(19) United States
(12) Patent Application Publication
(10) Pub. No.: US 2014/0257921 A1
(43) Pub. Date: Sep. 11, 2014

(54) SOCIAL INFLUENCERS METHOD AND SYSTEM

(71) Applicant: ORACLE INTERNATIONAL CORPORATION, Redwood Shores, CA (US)

(72) Inventors: Mary E. G. BEAR, Burlingame, CA (US); Tara U. ROBERTS, Austin, TX (US)

(73) Assignee: ORACLE INTERNATIONAL CORPORATION, Redwood Shores, CA (US)

(21) Appl. No.: 13/794,294

(22) Filed: Mar. 11, 2013

(51) Int. Cl. G06Q 30/02

(52) U.S. Cl. CPC G06Q 30/0269
USPC 705/7.29; 705/14.13

(57) ABSTRACT

Disclosed is an approach for implementing a system, method, and computer program product for providing a more complete approach to analyzing the commercial importance of individuals on interactive websites. Person of high commercial importance can be identified even where those individuals are not themselves directly spending high monetary amounts on personal purchases.

### BACKGROUND

Commerce is often affected by person-to-person interactions that influence purchase decisions by consumers. It has long been known that reviews, referrals, and recommendations between fellow consumers can have significant effects upon desirability of purchasing reviewed/recommended products and services. A positive recommendation may drive increased sales of the product, while negative reviews may serve to prevent potential sales by consumers.

In the past, the effects of person-to-person interactions on commerce were often sharply limited by the localized nature of the interactions. However, modern interactive websites, such as social networks and blogs, now allow almost anyone to have widespread reach with respect to distribution of that person's comments and messages. It is therefore in the best interests of businesses to facilitate positive person-to-person influenced commerce for their products and services on social media and blog websites. This may be implemented, for example, by providing incentives and rewards to persons on the social media and blog websites to refer and recommend consumers to go out and buy a business' product or service.

However, a business does not normally have unlimited resources, and therefore cannot provide extensive incentives and rewards to everyone on the social media sites. Instead, it would be most efficient for the business to be able to identify the key influencers on social media, and to target the incentives and rewards for those key influencers. The problem is that given the widespread availability of the interactive websites, social media sites, and blogs, literally anyone with a computer is capable of having a presence in the social media universe. This makes it very difficult for the business to understand which of the many millions of users on social media should be targeted for the marketing incentives.

Conventionally, business organizations tend to view the importance of individuals purely on the basis of revenue derived directly by purchases made by that individual. In other words, the commercial importance of any particular consumer is judged solely by how much that consumer spends on his/her own purchases. This is the conventional measure of the consumer's importance since purchase history is a metric that is relatively easy to track. However, in the internet age, this approach provides a very incomplete view of that customer's importance. This is especially true given the existence of many individuals that may not directly spend their own money on high purchase volumes, but are prominent enough on social media sites such that they can influence large numbers of other consumers to make purchases.

Therefore, there is a need for an improved approach to analyze the commercial importance of individuals on interactive websites.

### SUMMARY

Embodiments of the present invention provide a system, method, and computer program product for providing a more complete approach to analyzing the commercial importance of individuals on interactive websites. This allows individuals to be identified as having high levels of commercial importance to a business on the social media sites, even where those individuals are not themselves directly spending high monetary amounts on personal purchases. The invention performs a holistic analysis of the individuals to determine the amount of “influence” possessed by those individuals, sufficient to identify “influencers” that are present on the social media sites. This, in turn, permits businesses to generate increased revenues by efficiently targeting its marketing efforts at the identified influencers.

Other additional objects, features, and advantages of the invention are described in the detailed description, figures, and claims.

### BRIEF DESCRIPTION OF THE FIGURES

FIG. 1 illustrates a system to implement influence analysis according to embodiments of the invention.

FIG. 2 illustrates an approach to perform influence analysis according to embodiments of the invention.

FIG. 3 illustrates a flowchart of an approach to perform influence analysis according to embodiments of the invention.

FIG. 4 illustrate an interface to configure influence analysis according to embodiments of the invention.

FIG. 5 illustrates data maintained for an analyzed influencer according to embodiments of the invention.

FIG. 6 illustrates a flowchart of an approach to calculate a commercial importance score according to embodiments of the invention.

FIG. 7 illustrate an example approach to display referral participation according to embodiments of the invention.

FIG. 8 illustrates an example relationship and activities graph according to embodiments of the invention.

FIG. 9 depicts a computerized system on which an embodiment of the invention can be implemented.

### DETAILED DESCRIPTION

Embodiments of the present invention provide a system, method, and computer program product for providing a more complete approach to analyzing the commercial importance of individuals on interactive websites.

With the advent of social media, it has become very important to businesses to be able to analyze social media content to obtain a true picture of the commercial importance of individual that provide content to social media sites. This allows the businesses to understand the behavior and influence of individuals that generate the social media content. By understanding the commercial importance of the individuals that generate social media content, the business can more effectively and efficiently direct marketing activities at the individuals having high levels of commercial importance. This, in turn, permits businesses to generate increased revenues from its marketing activities.

“Influence” is one way to measure the extent of the commercial importance for an individual. Social influence is a numerical score calculated using variables in social media assigned to a person. In addition, specific behaviors are analyzed to determine how loyal a given individual is to the brand of interest to the business. This measure identifies the extent of positive and/or negative behaviors and expressions made by that individual for those brands. Commercial importance can then calculated by looking the relative influence of that individual combined with the individual's loyalty to the brands and products/services offered by the business.

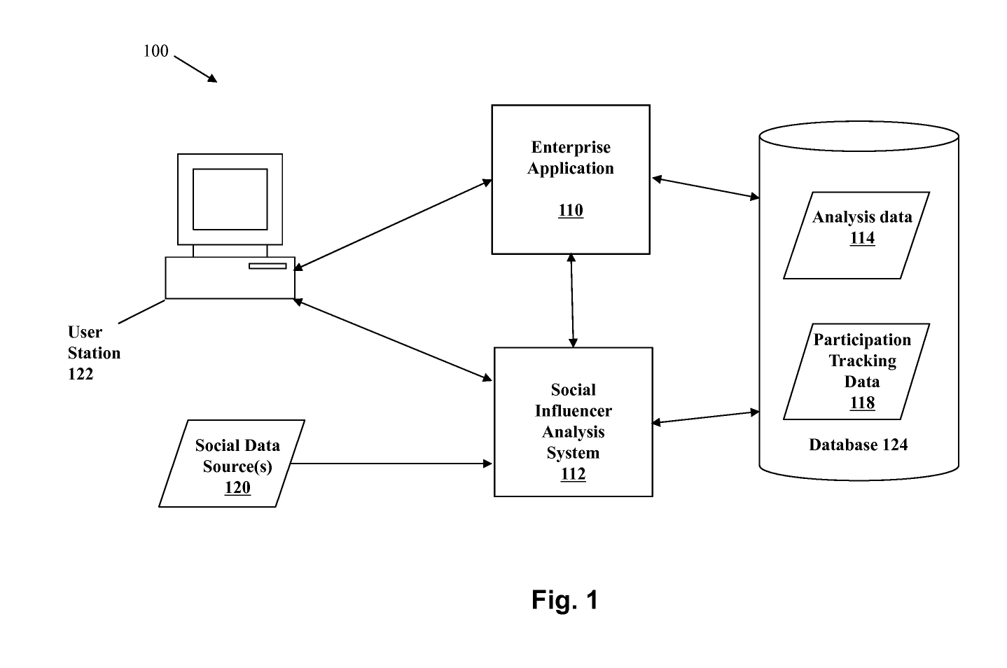

FIG. 1 illustrates an example system 100 which may be employed in some embodiments of the invention to analyze the commercial importance of individuals on interactive websites. The system 100 includes one or more users at one or more user stations 122 that operate the system 100. The user station 122 comprises any type of computing station that may be used to operate or interface with the applications in the system. Examples of such user stations include, for example, workstations, personal computers, or remote computing terminals. The user station 122 comprises a display device, such as a display monitor, for displaying a user interface to users at the user station. The user station 122 also comprises one or more input devices for the user to provide operational control over the activities of the system 100, such as a mouse or keyboard to manipulate a pointing object in a graphical user interface.

The system 100 includes a social influencer analysis system 112 that interacts with an enterprise application 110. The social influencer analysis system 112 receives data from one or more online social data sources 120. Such social data sources include, for example, websites such as a social network or blog or web feed (e.g., Facebook, Twitter, Blogger, and RSS). The content may include one or more comments (e.g., Facebook comment, comment to a blog post, reply to a previous comment) or uploaded postings (e.g., images and associated metadata, text, rich media, URLs) at one or more sources. The social data/content may therefore comprise a variety of forms and/or types.

The social influencer analysis system 112 uses the data from the social data sources 120 to generate analysis data 114 that identifies the amount of influence possessed by individual users of the social media sites. This analysis data 114 permits identification of notable influencers that are present on the social media sites, and which can be used by an enterprise application 110 to specifically target marketing activities at the identified influencers.

The enterprise application 110 comprises any business-related application that provides visibility and control over various aspects of a business. Such enterprise/business applications can include, without limitation, customer relations management (“CRM”) applications. Brand managers can use the CRM application to create, develop, extend, and build relationships with the identified influencers, and by extension, to the customers or potential customers that interact in some way with the influencer.

Participation tracking data 118 can be maintained to track the real-world effects of marketing activities that were targeted to the influencers. For example, the marketing activities may involve sending of discount or coupon codes to the identified influencers, where the discount/coupon codes have an identification numbers that are unique to specific influencers. By tracking the actual purchases made by consumers using the different discount/coupon codes, the business can identify which of the identified influencers have provided real commercial benefit to that business.

The data maintained by the system 100, such as analysis data 114 and participation tracking data 118, are stored in a database 124 onto one or more computer readable storage devices. The computer readable storage device(s) comprise any combination of hardware and software that allows for ready access to the data that is located at the computer readable storage device. For example, the computer readable storage device could be implemented as computer memory operatively managed by an operating system. The computer readable storage device could also be implemented as an electronic database system having storage on persistent and/or non-persistent storage.

For the purposes of explanation, one or more embodiments are illustratively described with reference to CRM applications. It is noted, however, that the invention may be applied to other types of enterprise applications as well, and is not to be limited to CRM applications unless explicitly claimed as such.

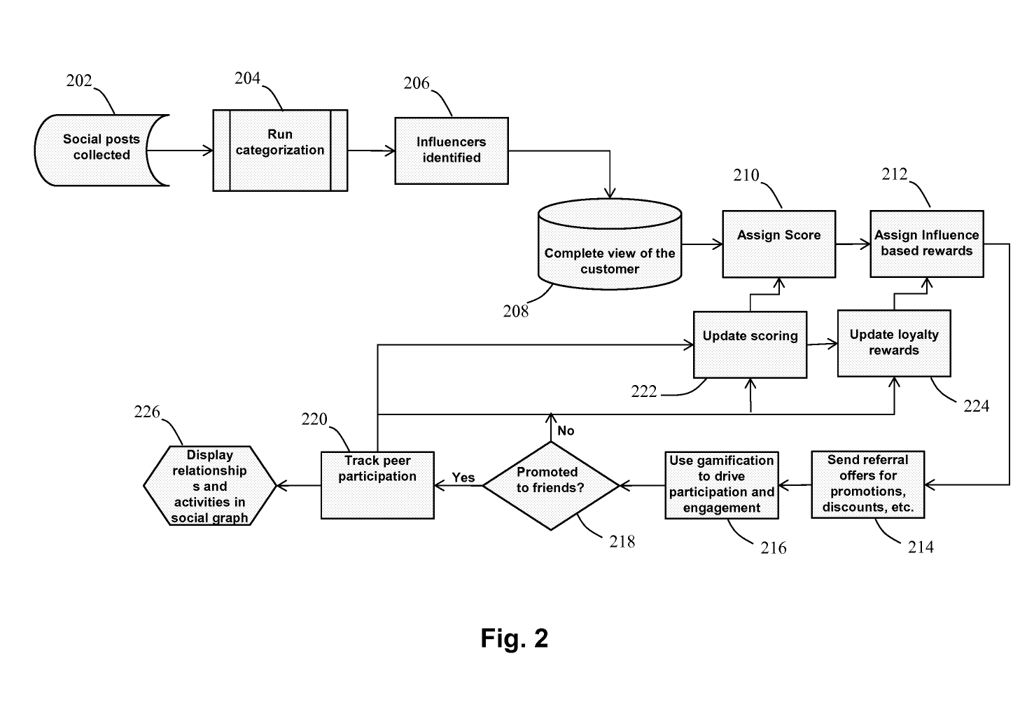

FIG. 2 shows an illustrative approach for analyzing the commercial importance of individuals on interactive websites according to some embodiments of the invention. At 202, data from social network systems are received into the system. The data can be received from any type of social data source, including for example, websites such as a social network or blog or web feed (e.g., Facebook, Twitter, Blogger, and RSS). The content may include one or more comments (e.g., Facebook comment, comment to a blog post, reply to a previous comment) or uploaded postings (e.g., images and associated metadata, text, rich media, URLs) at one or more sources.

The social data may be extracted based upon a list of certain individuals of interest. Such individuals may include, for example, existing or past customers, marketing contacts, and public figures. Alternatively, the social data may be generally acquired from the social network systems, without upfront filtering based upon a designated list of individuals.

The social data may be extracted based upon content or topics of interest. This permits the system to listen or specific topics of interest to the business.

At 204, categorization analysis is performed on the social data. Categorization, sentiment, and other metadata can be collected to enable calculation of social influence. Such analysis may be performed, for example, by implementing semantic filtering and analysis upon the social data. For example, latent semantic analysis (LSA), an advanced form of statistical language modeling, can be used to perform semantic analysis upon the social data. This permits the system to understand the contextual and semantic significance of terms that appear within the social data. For example semantic analysis can be used to understand the difference between the term “Galaxy” used for an astronomy contexts and “Galaxy” the name of a professional soccer team.

Semantic filtering is a mechanism that is provided to minimize miscategorizations of the social data. Much of the social data is likely to contain content which is of very little interest to a business organization. Semantic filtering is used to remove the irrelevant material from the social data to reduce the occurrence of false positives, false negatives, and inappropriate responses/rejections within the actionable data. This permits the resulting data to be more relevant and accurate when provided to the enterprise applications.

In some embodiments, all social data content is subject to semantic filtering to reduce the excess “noise” of irrelevant data. In an alternate embodiment, only public social network content undergoes semantic filtering, such that the private social network content is not subject to the semantic filtering. This embodiment is based on the assumption that the public social network content is more likely to contain data of little interest to the enterprise. In yet another embodiment, both the public and private social network data are subject to semantic filtering, but the filtering is handled differently so that greater levels/intensity of filtering is imposed on the public data as opposed to the private data.

The system performs semantic analysis and classification to the social media data. This permits the system to create and apply filters to identify themes, and to cluster together like-minded messages, topics, conversations, and content. There are numerous ways that can be taken to semantically categorize the social network content. The categorizations and classifications can be performed with an eye towards identifying, for example: (a) insights, preferences, and intentions; (b) demographic and social information; (c) customer insights, preferences, and intentions; (d) trends and emerging themes; and (e) customer/consumer viewpoints, e.g., on price and product considerations, services, and customer satisfaction.

An example tool that can be used to implement 204 is the Collective Intellect product, available from Oracle Corporation of Redwood Shores, Calif.

Influencers are then identified at 206. Social influence is a numerical score calculated using many variables in social media assigned to a person in order to stack rank or group the individuals on social media. Enterprises can understand their value, impact, and/or expertise, and use this information to take intelligent action to impact behavior of others.

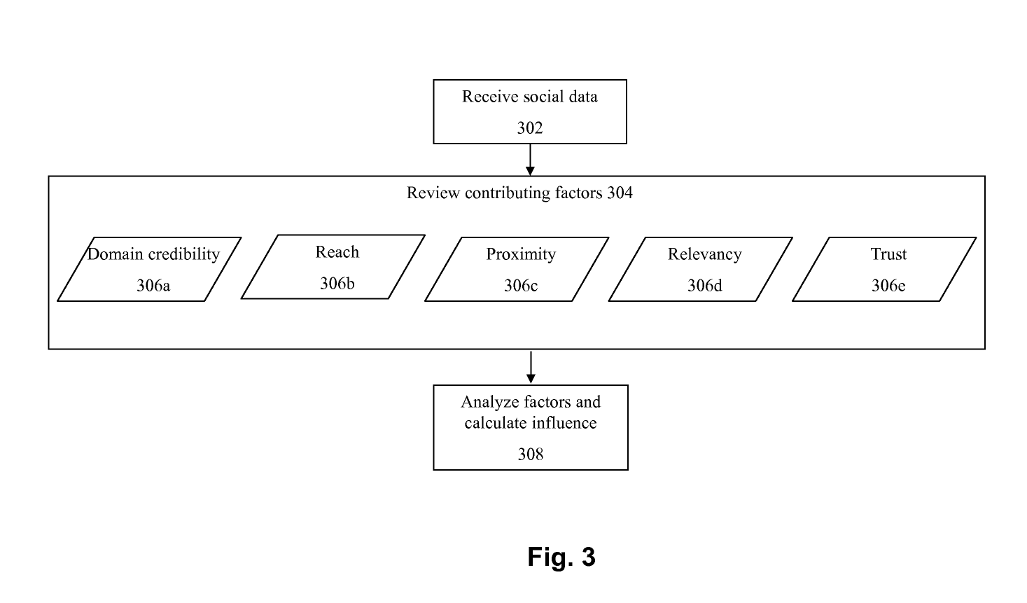

FIG. 3 shows a flowchart of an approach for identifying influencers according to an embodiment of the invention. At 302, social data is acquired to perform the analysis, e.g., using the categorization analysis performed at 204. The analysis may also be performed using social profile data, such as profile data associated with the originator of specific items of social network content. This profile data includes, for example, information about the social “importance” of that person, e.g., using Klout data, follower count, etc. The profile data may also include demographic information about the person, including information about the person's income, age, profession, and geographic location.

At 304, contributing factors are analyzed and reviewed. These contributing factors include, for example, domain credibility 306a, reach 306b, proximity 306c, relevancy 306d, and trust 306e. These factors can be used in any combination, and other factors may also be used as well.

Domain credibility for a person often depends on a specific topic and/or brand. The domain credibility for a person may fall into limited number of knowledge domains or areas of expertise, interest, and/or enthusiasm. Therefore, an individual may have high domain credibility for a first topic/brand, but have very low domain credibility for a second topic/brand.

The reach for an individual indicates how fast or far that person can make an impact on a particular topic or brand. This factor often depends on the size of that person's network, participation velocity, and/or social equity. For example, a first individual may have high reach since that person has 600 people in his network who has active engagements, while a second individual has lower reach since that person has only 10 people in her network that are less active.

The proximity factor pertains to the size of an engaged audience for an individual, and indicates the relationships between people and how they are connected. This can be an important factor to distinguish between the popularity versus the influence of an individual. For example, a fashion expert may not necessarily be popular but may be quite influential with respect to women's apparel, whereas a movie star such as Brad Pitt may be very popular but is likely not very influential for this same topic.

The relevancy of an individual indicates the potential influence that a person has within a given community/social network. This factor depends on many parameters such as time, channel, content, and/or location. For example, when a consumer is in the market to buy a new purse, then when a second individual shares a special offer she received from a purse manufacturer, then this is highly relevant content for the consumer at that point in time.

The trust for an individual indicates the true reach for that person. This factor may pertain to many areas, such as product ratings, reviews, and/or level of direct engagement. For example, consider a situation where person A and person B are connected, and these two individuals engage frequently on social media. When person A recommends something, person B frequently acts on the suggestions. This indicates that person B's trust in person A is high.

At 308, the factors are analyzed to determine the influence score for an individual. In one embodiment, each of these factors is given a value, and the overall score/value is obtained by combining the individual value for these factors. Each of these values can be weighted as appropriate for the goals of the enterprise.

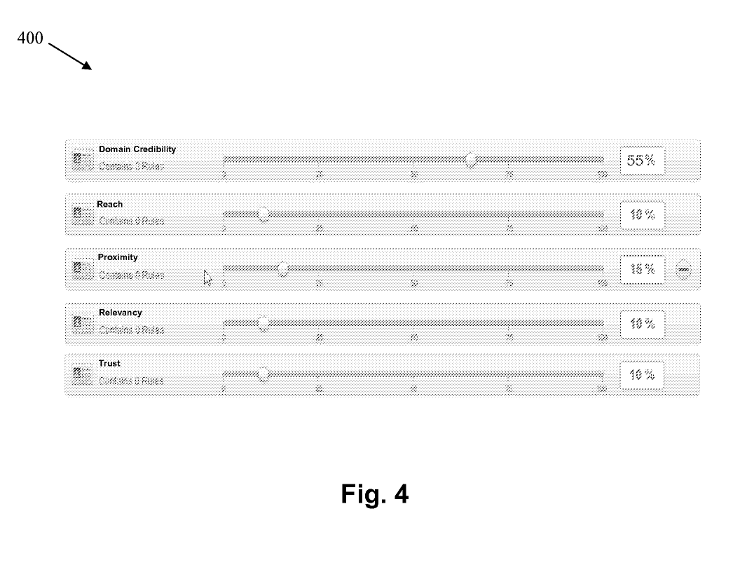

The weighting of these factors can be adjusted to determine the relative contribution of each one to the overall score. FIG. 4 shows an example interface 400 that can be used to adjust the relative contribution of each factor to the overall influence score for the individual. Slide control interfaces may be used to adjust the relative importance of these factors to the overall influence score.

Returning back to FIG. 2, data 208 is thereafter created and maintained for the individuals, which includes a complete view of the analyzed individuals/customers/influencer. The data 208 can be used to maintain and display demographic and/or psychographic information about the analyzed individuals. The data 208 can also be used to identify signals for customer interests, concerns, affinity, and/or other items of interests from social media posts. The data can be obtained from any type of source, including structured, semi-structured, and unstructured sources.

In addition, the data 208 can be used to map the individual/contacts to their public social profiles. For example, the mapping data can create new contact records with public social profile information, including for example, names, social network ID, etc. The social profile information can be merged with an existing contact record, with selectable attributes and values to merge. The contact record information can be enriched with 3^{rd} party provided information, e.g., from sources such as D&B (Dunn & Bradstreet), ZoomInfo, Fliptop, and Epsilon.

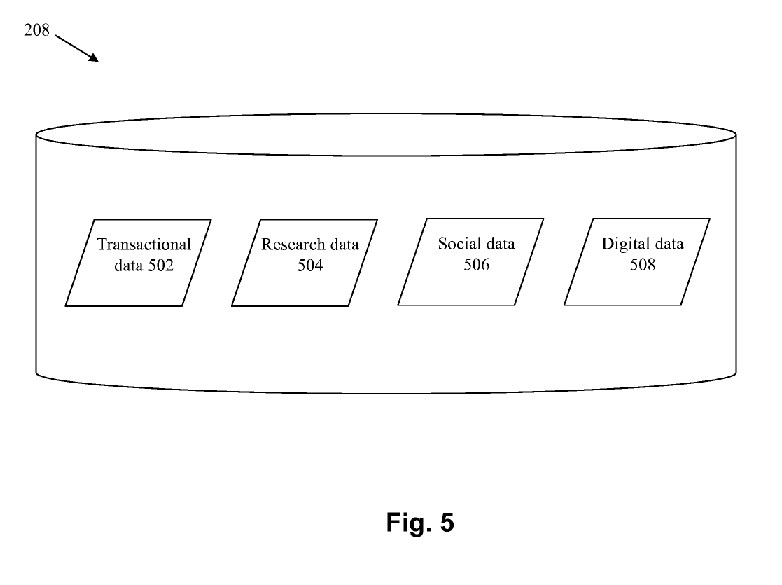

FIG. 5 illustrates a possible approach to implement a complete view of the individual/contact according to some embodiments of the invention.

In some embodiments, transactional data 502 comprises some or all of the following:
Profile info: First name, last name, DOB,
Occupation info: Organization, job title, co-workers, org chart
Contact info: Address, phone, email
Order History: Order id, items purchased, purchase amount, date, status
Sales History: Activity id, sales rep, activity detail, follow up activity
Customer Service History: Service Request number, SR details, status
Marketing History: Campaign id, offer details, behaviors (viewed, shared, purchased . . . )

In some embodiments, research data 504 comprises survey information. Such information includes, for example, surveys, questions, responses, date, and the like.

In some embodiments, social data 506 comprises some or all of the following:
Profile Info: Social Media ID, picture, location, website/links, bio, education, status, gender
Connection Info: Social network connections, engagement activities
Scoring Info: Influence, sentiment
Indicators: Intent, interest, customer service
Post Info: Post date, post details, social media source

In some embodiments, digital data 508 comprises some or all of the following:
Web Purchase Interaction Info: Which links clicked, # of times clicked, abandon shopping cart items, etc.
Gamification Interaction Info: which games engaged, duration, behavior (purchased, shared . . . )
Other Digital Interaction Info: relevant information from call center transcripts, emails, chats

In some embodiments, the system will capture information for the person specifically in the context of an enterprise's competitors. Such information may also include other items of information described herein. This information includes, for example, a loyalty score for the person relative to a competitor. This loyalty information can be used, for example, to determine the relative loyalties of a person between multiple enterprises and/or brands.

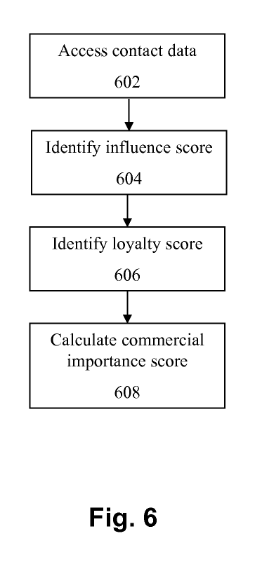

At 210 of FIG. 2, a commercial importance score is assigned to the individual. The commercial importance score provide a valuation amount that can be used to estimate the expected commercial importance of the individual to the business. FIG. 6 shows a flowchart of an approach for implementing a score for the individual. The process begins at 602 by accessing the data for the individual being analyzed.

At 604, identification is made of the influence value of the individual being analyzed. This is a value calculated at 206 to identify the influencers. At 606, a loyalty value is identified for the individual. This value provides a metric that estimates the extent that the individual is loyal to the brands provided by the business.

At 608, the loyalty and influence of the individual is analyzed to determine an overall commercial importance score for the individual. Each of these values contributes to the overall score of the individual. Therefore, a person having both a high influence value and a high loyalty value would be deemed to have a high commercial importance score. On the other hand, a person having a low influence value combined with a low loyalty value would likely have a very low commercial importance score.

A high value for one factor could balance out a low value for the other factor. For example, a person having a relatively low loyalty value may still have an acceptably high commercial importance score if that person has a high enough influence score. Similarly, a person having a relatively low influence value may still have an acceptably high commercial importance score if that person has a high enough loyalty score.

Each of these values can be weighted as appropriate for the goals of the enterprise. The weighting of these factors can be adjusted to determine the relative contribution of each one to the overall score.

At 212 of FIG. 2, rewards can be provided to the individual based at least in part upon the commercial importance of that individual. For example, the amount of the reward may be set high for individuals having relatively high levels of commercial importance, while lower reward amounts may be designated for individuals having relatively lower levels of commercial importance. The amount and type of the reward can also be selected to further the intended goal of the enterprise. For example, if the goal is intended to motivate the individual to distribute offers or promotions for the business' products, then the reward is selected to incentivize the individual to make such distributions and referrals.

At 214, referral offers are provided to the identified individuals. These referral offers include any type of marketing promotion that is intended to be referred from one individual to any other individual. Such offers include, for example, discount codes, coupons, advertisements, free offers, promotional video clips, and the like.

The hope is that the referral offers would be passed from the influencer to other individuals/consumers. If the influencer really possesses a measure of influence over other consumers, then increased revenues can be driven by having the influencer send the referral offer to others.

Tracking data may be associated with the referral offers. For example, the referral offer may be associated with an identification number that is unique to specific influencer to whom the referral offer was initially provided. As a result, when any of the referral offers are redeemed by any consumer, it is possible to determine with exact specificity which of the influencers had provided the referral that results in the sale/redemption by the consumer.

In some embodiments, at 216, gamification may be used to drive participation by the influencer. Gamification refers to the application of game design principles and mechanics to an enterprise. Participants gain points and badges by completing tasks determined by the application administrator, e.g., based upon the amount and type of referrals made by the influencer. In the present context, gamification can be used to motivate greater participation by the influencers to provide the referral offers to other consumers.

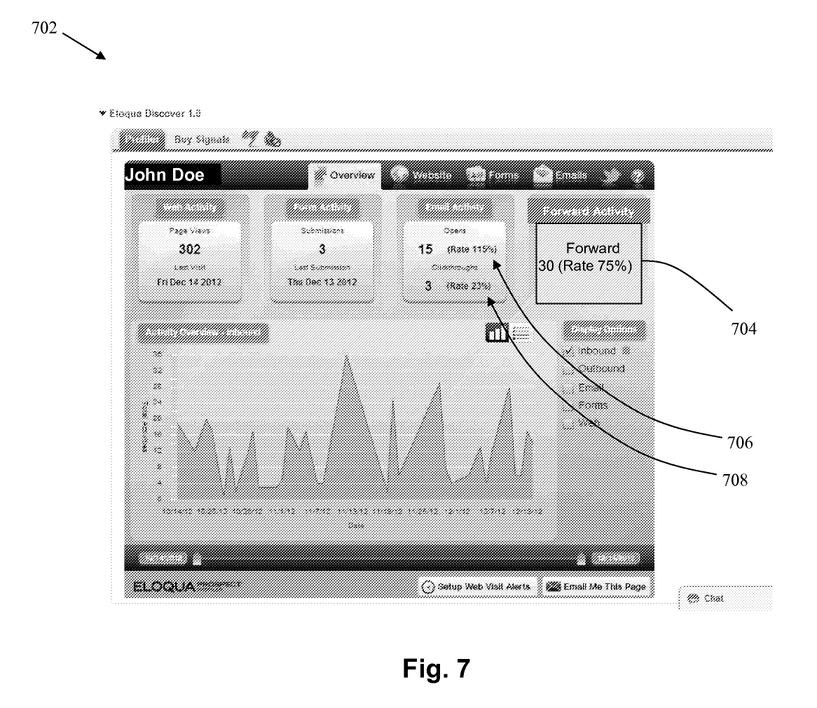

A determination is made at 218 whether or not the referral offers have actually been promoted to other consumers. Any suitable approach can be taken to evaluate whether and to what extent the offers have been referred to others. For example, the Eloqua Discoverer product (available from Oracle Corporation of Redwood Shores, Calif.) may be used to track such referrals. FIG. 7 illustrates an example interface 702 that can be used to display the results of this type of evaluation, identifying, for example, how many offers have been forwarded (704), the number of referred offers that have been opened (706), and the number of offers that actually experienced a “click through” by the consumer (708).

If the referrals have been made, then at 220, tracking is performed for participation in the referral offers. By tracking the actual purchases made by consumers, the business can identify which of the identified influencers have provided real commercial benefit to that business. Tracking is performed, for example, by checking the specific identification number that is associated with the referral offer, where the identification number is unique to specific influencer to whom the referral offer was initially provided. Therefore, when any of the referral offers are redeemed by a consumer, it is possible to determine which of the influencers had provided the referral that caused the sale/redemption by the consumer. Even if the offer goes viral and passes through many chains of referrals, the unique identification number allows the original influencer of the offer to be identified.

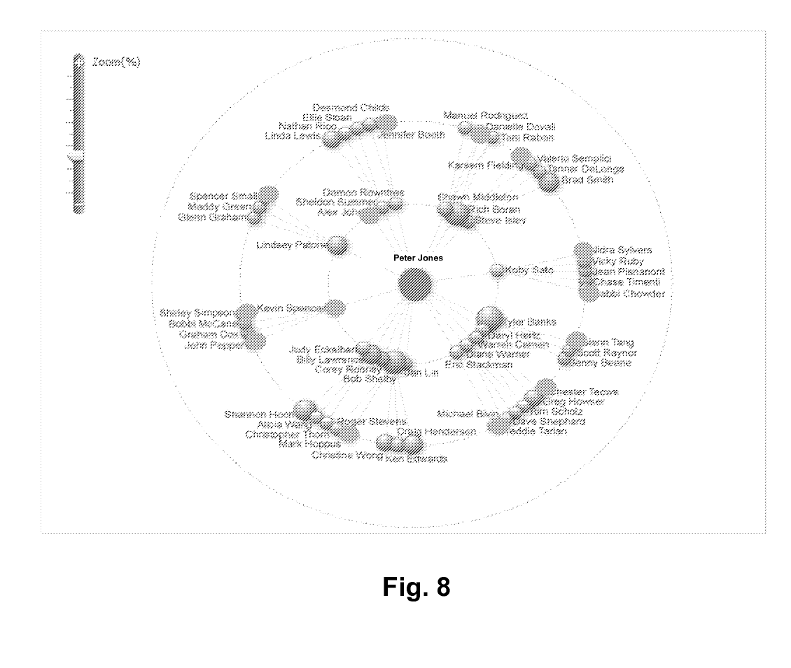

At 226, a user interface can be provided to display relationships and activities for the referral offer and the influencer. FIG. 8 shows an illustrative example of an interface that can be used to display this type of information.

At 222, the results of the referral and participation analysis can be used to update the commercial importance score for the individual. This provides a feedback process that allows for a more accurate assessment of the actual commercial importance of the influencer to the enterprise. If the individual does not refer the offer to others or provides only a relatively small number of referrals, then this may result in a reduction in the person's loyalty score, which would reduce that person's overall commercial importance score. On the other hand, if the individual provides a relatively large number of referrals and/or provides the referrals with very positive reviews, then this may result in an increase in the person's loyalty score, which would increase that person's overall commercial importance score.

When the influencer does provide referrals to other, the measured level of participation in the offers resulting from those referrals may be used to update the commercial importance score for the influencer. For example, if there is a high level of participation in the referred offer, this could result in an increase in the person's influence score, which would increase that person's overall commercial importance score. On the other hand, if there is a low level of participation in the referred offer, then this is evidence that the person should have a low influence score, which would decrease that person's overall commercial importance score.

At 224, the amount and/or type of rewards provided to the influencer can be updated based upon the updated commercial importance score for the influencer. If the commercial importance score is increased, then this may result in increased amounts of rewards for the person. If the commercial importance score is decreased, then this may result in decreased amounts of rewards for the person.

Therefore, what has been described is an approach for implementing a system, method, and computer program product for providing a more complete approach to analyzing the commercial importance of individuals on interactive websites. This allows individuals to be identified as having high levels of commercial importance to a business on the social media sites. Since the analysis is performed over a complete picture of the individual, this means that person of high commercial importance can be identified even where those individuals are not themselves directly spending high monetary amounts on personal purchases.

### System Architecture Overview

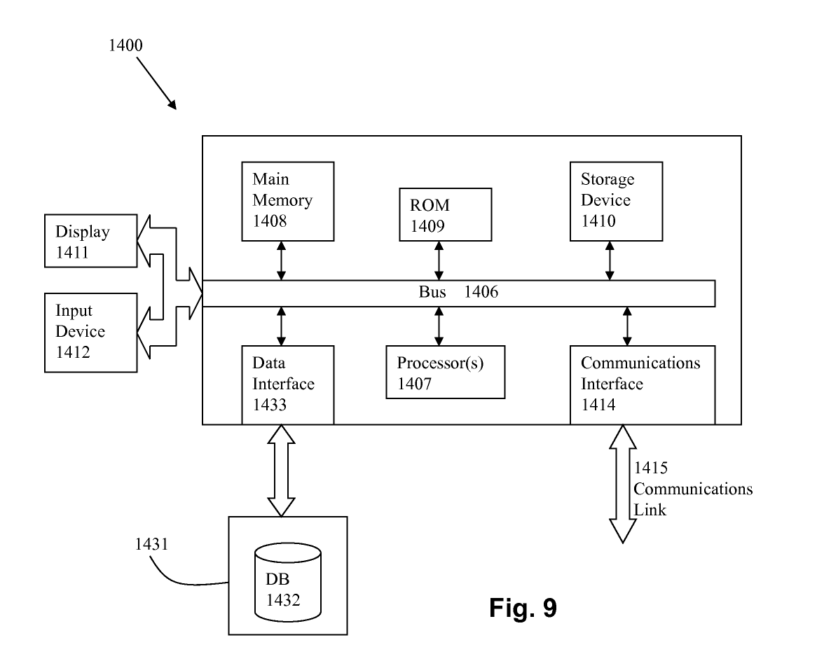

FIG. 9 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A computer implemented method implemented with a processor for performing analysis, comprising:
collecting social media data;
generating an influence value using the social media data;
generating a loyalty value using the social media data; and
determining a commercial importance score based at least in part on the combination of the influence value and the loyalty value.

2. The method of claim 1, in which semantic analysis is performed to generate at least one of the influence value or the loyalty value.

3. The method of claim 1, in which the commercial importance score is used to assign an award to a customer.

4. The method of claim 3, in which the award is tracked for referral to other customers.

5. The method of claim 4, in which tracking results are used to update the commercial importance score.

6. The method of claim 3, in which the award comprises at least one of a coupon code or a discount code.

7. The method of claim 3, in which the award comprises an identifier that identifier a source promoter for the award.

8. The method of claim 1, in which an enterprise application is used to maintain information about scoring for analyzed customers.

9. The method of claim 1, in which at least one of the following factors are analyzed to generate the influence value: domain credibility, reach, proximity, relevancy, and trust.

10. The method of claim 1, in which the social media data comprises a social profile for an individual.

11. The method of claim 1, in which weighting of the influence value or loyalty value is performed.

12. The method of claim 1, further comprising gamification to incentivize an increase in the commercial importance score.

13. A computer program product embodied on a computer usable medium, the computer readable medium having stored thereon a sequence of instructions which, when executed by a processor causes the processor to execute a method for performing analysis, the method comprising:
collecting social media data;
generating an influence value using the social media data;
generating a loyalty value using the social media data; and
determining a commercial importance score based at least in part on the combination of the influence value and the loyalty value.

14. The computer program product of claim 13, in which semantic analysis is performed to generate at least one of the influence value or the loyalty value.

15. The computer program product of claim 13, in which the commercial importance score is used to assign an award to a customer.

16. The computer program product of claim 15, in which the award is tracked for referral to other customers.

17. The computer program product of claim 16, in which tracking results are used to update the commercial importance score.

18. The computer program product of claim 15, in which the award comprises at least one of a coupon code or a discount code.

19. The computer program product of claim 15, in which the award comprises an identifier that identifier a source promoter for the award.

20. The computer program product of claim 13, in which an enterprise application is used to maintain information about scoring for analyzed customers.

21. The computer program product of claim 13, in which at least one of the following factors are analyzed to generate the influence value: domain credibility, reach, proximity, relevancy, and trust.

22. The computer program product of claim 13, in which the social media data comprises a social profile for an individual.

23. The computer program product of claim 13, in which weighting of the influence value or loyalty value is performed.

24. The computer program product of claim 13, further comprising gamification to incentivize an increase in the commercial importance score.

25. A system for performing analysis, comprising:
a processor;
a memory comprising computer code executed using the processor, in which the computer code implements collecting social media data, generating an influence value using the social media data, generating a loyalty value using the social media data, and determining a commercial importance score based at least in part on the combination of the influence value and the loyalty value.

26. The system of claim 25, in which the computer code implements semantic analysis to generate at least one of the influence value or the loyalty value.

27. The system of claim 25, in which the commercial importance score is used to assign an award to a customer.

28. The system of claim 27, in which the award is tracked for referral to other customers.

29. The system of claim 28, in which tracking results are used to update the commercial importance score.

30. The system of claim 27, in which the award comprises at least one of a coupon code or a discount code.

31. The system of claim 27, in which the award comprises an identifier that identifier a source promoter for the award.

32. The system of claim 25, in which an enterprise application is used to maintain information about scoring for analyzed customers.

33. The system of claim 25, in which at least one of the following factors are analyzed to generate the influence value: domain credibility, reach, proximity, relevancy, and trust.

34. The system of claim 25, in which the social media data comprises a social profile for an individual.

35. The system of claim 25, in which weighting of the influence value or loyalty value is performed.

36. The system of claim 25, further comprising a user interface to track the analysis.

37. The system of claim 36, in which peer participation is viewable using the user interface.

38. The system of claim 25, in which a set of data is maintained for an individual being analyzed, where the set of data comprises transactional data, research data, social data, and digital data.
